(19) United States
(12) Patent Application Publication
(10) Pub. No.: US 2008/0069631 A1
(43) Pub. Date: Mar. 20, 2008

(54) Modular furniture

(76) Inventor: Dolf Zillmann, Fripp Island, SC (US)

Correspondence Address: WOLF GREENFIELD & SACKS, P.C., 600 ATLANTIC AVENUE, BOSTON, MA, 02210-2206, US

(21) Appl. No.: 11/521,935

(22) Filed: Sep. 15, 2006

(51) Int. Cl. F16B 7/10

(52) U.S. Cl. 403/108

(57) ABSTRACT

Furniture connectors and modular furniture systems are disclosed. The furniture connectors may be configured to include furniture-engaging portions that are inserted into grooves that extend along connection sides of furniture members. The furniture connectors can include at least two furniture-engaging portions and may include elongated connecting elements extending from the furniture-engaging portions. The elongated connecting elements may be fastened to furniture members to connect multiple furniture members together in a secure manner in a variety of assembly configurations. The modular furniture systems disclosed may use easy-to-assemble connectors and strong, reversible connections that may permit disassembly and reassembly, optionally, into a different furniture configuration than the one disassembled. Expandability without disassembly or part removal may further augment the versatility of the system.

### FIELD OF INVENTION

The present invention relates generally to modular furniture and more specifically to furniture connectors, modular furniture systems, and methods of connecting and disconnecting components of furniture.

### DISCUSSION OF RELATED ART

Furniture assembly, whether performed by the consumer or the furniture manufacturer, can be a time-consuming process involving the use of tools, numerous pieces of hardware, and extensive, complex instructions. The relative ease or difficulty of assembly often has an impact on the cost to manufacture, storage, distribution and/or other aspects of the marketability of the furniture to the consumer. Additionally, the ease of assembly can also have a substantial effect on the utility of a modular furniture system.

Furniture that is shipped as a packaged kit of separate furniture parts and is intended to be assembled by a retailer or a consumer is often referred to as knock-down furniture or assembly furniture. Knock-down furniture kits are typically shipped in large flat packages that include flat furniture members (e.g., walls, bases, doors, shelves, dividers, etc.) and a set of instructions for assembling the furniture members into a piece of furniture such as a desk or a shelving unit.

A fairly common method of connecting the furniture members of a knock-down furniture kit is described in U.S. Pat. No. 4,886,326 to Kuzyk. A cam lock is inserted into a drilled recess in a first furniture member, and a connecting bolt, attached to a first furniture member, is inserted through a bore into the cam lock. The cam lock is rotated to lock the connecting bolt in place. In this manner the two furniture members are connected at a point connection. Several of these point connections are provided along the sides of furniture members that are to be connected.

Typical knock-down furniture kits include furniture members and other components that are not designed to permit easy disassembly without a deterioration in the usefulness or aesthetic quality of the furniture members and/or other components, such as connectors. In typical prior art knock-down furniture, the furniture members and connection system typically are designed to allow only one assembly configuration. For example, connectors and associated furniture members can be configured to permit interconnection of only a specific number of furniture members in a specific, predetermined arrangement.

A simplified and more flexible system for connecting furniture members would significantly reduce furniture assembly time requirements and improve versatility.

### SUMMARY OF INVENTION

Fewer parts, interchangeable parts, flexibility of assembly configuration, simplified expansion, and secure connections can each help to provide a straightforward system for interconnecting furniture members to form furniture assemblies. Various embodiments of a furniture system disclosed herein permit a user to securely interconnect furniture members with furniture connectors that may be interchangeable and versatile. In some embodiments, a piece of furniture, such as a shelving unit for example, may be assembled using components described herein, and, if expansion of the shelving unit is desired, additional shelves may be added without disassembly of the existing shelving unit. In some cases, the piece of furniture may be expanded without removing a single furniture connector, furniture member, connecting element or fastening element from the existing configuration.

According to one embodiment of the invention, a furniture system includes a furniture connector which extends in a lengthwise direction and includes a plurality of furniture-engaging portions. The furniture system also includes furniture members, at least two of which each include a groove formed at or near a connecting side of the furniture member, the groove being configured to accept a furniture-engaging portion of the connector. Elongated connecting elements and fastening elements are also included in the system. For each of the at least two furniture members, at least one elongated connecting element extends between a furniture-engaging portion of the connector and the furniture member at a discrete location along the length of the connector. The at least one connecting element and the at least one fastening element are configured to engage one another to secure the furniture-engaging portion within the groove of the furniture member.

According to another embodiment of the invention, a furniture system includes furniture members with at least two of the furniture members each including a furniture connector-engaging portion formed at or near a connecting side of the furniture member. The system also includes a furniture connector which extends in a lengthwise direction and has grooves, with at least two of the grooves each configured to accept a furniture connector-engaging portion of one of the at least two furniture members. Elongated connecting elements and fastening elements are also included in the system. For each of the at least two furniture members, at least one elongated connecting element is attached to the furniture connector and extends away from the furniture connector at a discrete location along the length of the connector. The at least one connecting element is configured to engage a fastening element to secure the furniture connector-engaging portion of the furniture member within a groove of the furniture connector.

According to a further embodiment of the invention, a furniture connection system includes a furniture connector that extends in a lengthwise direction and includes at least first, second and third furniture-engaging portions comprising edges of the furniture connector extending in the lengthwise direction along at least a portion of the length of the furniture connector. Each of the first, second and third edges are formed by the intersection of two substantially planar surfaces of the furniture connector, and each of the first, second and third edges include at least one hole formed in the edge, each hole being configured to accept and attach an elongated connecting element. The furniture connection system further includes elongated connecting elements configured for attachment in the holes.

According to yet another embodiment of the invention, a method of assembling a piece of furniture includes providing a longitudinally-extending furniture connector with at least first and second furniture-engaging portions and attaching a plurality of connecting elements to the first and second furniture-engaging portions. The method further includes providing first and second furniture members, each furniture member having a groove at or near a connecting side of the furniture member, and additionally having passages disposed in a base and/or wall of the groove, and further including fastening element holes intersecting with the passages. Also included in the method is inserting fastening elements into the fastening element holes of the first and second furniture members, inserting the connecting elements that are attached to the first furniture-engaging portion into the passages in the base and/or wall of the groove of the first furniture member, and engaging the fastening elements with the connecting elements of the first furniture-engaging portion to attach the connecting elements to the first furniture member, thereby securing the first furniture member to the furniture connector. The method further includes inserting the connecting elements that are attached to the second furniture-engaging portion into the passages in the base of the groove of the second furniture member, and engaging the fastening elements with the connecting elements of the second furniture-engaging portion to attach the connecting elements to the second furniture member, thereby securing the second furniture member to the furniture connector.

### BRIEF DESCRIPTION OF DRAWINGS

The accompanying drawings are not intended to be drawn to scale. In the drawings, each identical or nearly identical component that is illustrated in various figures typically is represented by a like numeral. For purposes of clarity, not every component may be labeled in every drawing, nor is every component of each embodiment of the invention shown where illustration is not necessary to allow those of ordinary skill in the art to understand the invention. In the drawings:

FIG. 1 is a perspective view of a furniture connector connecting three furniture members according to one embodiment of the invention;

FIG. 2 is a perspective view of a furniture connector and a connecting element configured to be attached to the furniture connector according to one embodiment of the invention;

FIG. 3A is an end view of a furniture connector connecting three furniture members according to one embodiment of the invention;

FIG. 3B is an end view of a furniture connector connecting four furniture members according to an alternative embodiment of the invention;

FIG. 4 is an end view of a furniture connector connecting four furniture members according to another embodiment of the invention, two of the furniture members being shown in cross-section;

FIG. 5A shows one embodiment of a furniture assembly configuration;

FIG. 5B shows additional parts for adding an extension to the furniture assembly of FIG. 5A;

FIG. 5C shows the furniture assembly configuration of FIG. 5A with an extension added;

FIG. 6A shows one embodiment of a furniture assembly comprising furniture members and furniture connectors of the invention in a first configuration; and

FIG. 6B shows one embodiment of a furniture assembly assembled from the same furniture members and furniture connectors shown in FIG. 6A, and assembled in a second configuration.

### DETAILED DESCRIPTION

This invention is not limited in its structure or application to the details of construction and the arrangement of components set forth in the following description or illustrated in the drawings. The invention is capable of being embodied in other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, are meant to encompass the items listed thereafter as well as, optionally, additional items.

Certain embodiments of the invention provide a furniture system that permits simplified assembly, disassembly, and/or reassembly of a piece of furniture, compared with many typical conventional furniture systems. Additionally, in some embodiments, a furniture system is provided which allows for upward and/or sideward expansion of an existing furniture configuration without requiring any disassembly of the existing piece of furniture. In certain embodiments, an inventive furniture connector having furniture-engaging portions is used to interconnect furniture members provided according to the invention. For purposes herein, a “furniture member” comprises a shelf, wall, board, rail, door, leg, post, structural member, step, drawer, and any other furniture component that comprises a component of the useful structure of a piece of furniture or a furniture assembly, other than a furniture connector, a connecting element, or a fastening element, as those terms are used herein. For purposes herein, “interconnect” means to connect at least two elements, such as furniture members, whether they are directly connected or connected via a third, or more, intervening elements. A connection or interconnection does not necessarily require a fixed relation between the elements, as the elements may in certain embodiments be slidingly, pivotally, or rotatably interconnected.

In one embodiment, a furniture connector of the invention extends along a substantial length of the connecting sides at least two furniture members when the furniture members are interconnected with the furniture connector. For purposes herein, a “furniture member connecting side” is a side, an edge, or an area near a side or edge of a furniture member that is adapted to be interconnected with another furniture member. In certain embodiments, furniture member connecting sides are adapted to connect to furniture-engaging portions of a furniture connector as part of the interconnection between two furniture members.

In certain embodiments of a furniture member connection system, a furniture member has at least one groove in at least one of its connecting sides. At least one of such grooves may extend along the lengthwise direction of at least a portion of a connecting side, sometimes along essentially the entire length of such connecting side. In some such embodiments, the groove(s) may be adapted to receive and, in certain embodiments mate with, a furniture-engaging portion of a furniture connector. The use of grooves and furniture-engaging portions may provide a strong connection which more evenly distributes interconnection forces along the length of furniture members as compared to many conventional furniture assembly schemes. The furniture-engaging portion or a portion thereof may be configured as a rail, for example, a rectangular rail, or may be any other suitable structure that is insertable into the groove and adapted to enable secure fastening of the furniture member to the furniture-engaging portion. For certain embodiments of a furniture connector that have at least two furniture-engaging portions, two furniture members can be interconnected by inserting each furniture-engaging portion of the furniture connector into a groove of each of the furniture members, and fastening the furniture members to the furniture-engaging portions.

In certain embodiments, the furniture-engaging portion (rail or otherwise) that is insertable into the furniture member groove is configured to include one or more elongated connecting elements, such as bolts or other threaded connectors, attached to it. Each elongated connecting element, in turn, may be configured to be engageable with a fastening element associated with a furniture member so as to connect the furniture member to the furniture-engaging portion of the furniture connector. The furniture-engaging portion may include a recess such as a hole for insertion and attachment of at least a portion of (e.g. a threaded portion) the elongated connecting element. For example, the furniture-engaging portion may have a hole with internal threads to accept a bolt which is threaded at one end. In certain embodiments, with the furniture-engaging portion of a connector placed within a groove of the furniture member, and a connecting element extending into the furniture member through a passage in the base or wall of the groove, a fastening element which is disposed in a hole in the furniture member is operated upon to engage the connecting element to secure the furniture member to the furniture connector.

In some embodiments, the fastening of the furniture-engaging portions of the connectors to the furniture members is reversible. That is to say, the furniture-engaging portions of the connectors may be unfastened and removed from the grooves in the furniture members without changing the structure or damaging the connector or the furniture members so much as to cause them to be less useful or to substantially decrease their useful lifespan. By permitting removal of the connectors, certain groups of assembled furniture members provided according to certain embodiments of the invention can be disassembled from one selected configuration and, optionally, reassembled into a different configuration.

According to one aspect of certain embodiments of the invention, the assembly and/or the disassembly of furniture may be simplified by using certain embodiments of the connectors and furniture members described herein. The assembly of furniture in some embodiments may require very few tools, in some cases only a screwdriver. In other embodiments, no tools are required for assembly or disassembly, i.e. only the hands of an assembler. For example, a cam lock or other fastening element may be grooved for finger operation.

According to another aspect of certain embodiments of the invention, the interchangeability of the furniture members and/or the versatility of embodiments of the connector may simplify assembly and may permit furniture configuration changes. For example, a shelving unit may be assembled in one of a number of configurations and later disassembled and reassembled in a different configuration. In some embodiments, the same connector can interconnect two, three, or four or more furniture members. In one example, a connector is capable of interconnecting up to four furniture members, but when interconnecting fewer than four furniture members, the unused furniture-engaging portions do not protrude unacceptably from the piece of furniture. By adding or subtracting furniture members, a user can change the configuration of the furniture assembly. A kit of parts may be provided that includes interchangeable furniture members, furniture connectors, connecting elements, fastening elements and instructions. The instructions may direct a user to assemble the furniture connectors and furniture members into a first configuration. The instructions also may direct the user to disassemble the first configuration and assemble the furniture connectors and furniture members into a second, a third, etc. configuration, depending on the embodiment.

Using various connectors of the invention that can connect two, three, or four or more furniture members also may allow a user to expand a piece of furniture by adding new furniture members to the side, top, bottom, front, and/or back of a piece of furniture; in some embodiments without exchanging connectors. In certain embodiments, extensions may be added to furniture assemblies in this manner without the creation of double walls. For example, one side of a shelving unit may have a four-foot vertical wall that is made up of four one-foot square boards which are attached end-to-end by three furniture connectors, and additionally have a furniture connector at the top of the highest board and a furniture connector at the bottom of the lowest board. A user may expand the shelving unit on such side by attaching bolts to the outward-facing furniture-engaging portions of the five furniture connectors and connecting two horizontal boards to these furniture-engaging portions of the connectors. If desired, vertical boards may be added to the outer side of the assembly to complete the addition of a new shelf.

In another aspect of certain embodiments of the invention, the use of furniture connectors that extend lengthwise along connecting sides of furniture members can provide stronger connections between furniture members than achieved using typical connection means utilized for modular furniture. In some embodiments, the furniture connectors can extend along essentially the entire length or a major portion of the length of the connecting side of a furniture member. In certain embodiments the furniture connectors do not extend along the entire length of the connecting side, but the connector length is greater than the connector width. As compared to typical conventional point connection furniture assembly systems, such connections may help distribute loads applied to the furniture connectors and furniture members over a greater area to increase load-carrying capacity of assembled furniture and/or reduce the chance of damage or breakage.

In another aspect of certain embodiments of the invention, furniture members may be provided which include adapters that are configured to allow connection of door hinges, sliding doors, shelving, feet, wheels, handles, or other suitable items or furniture members.

According to another aspect of certain embodiments of the invention, fastening elements used to secure the furniture connectors to the furniture members can be hidden from exterior view in an assembled piece of furniture. In some embodiments, the fastening elements are employed on interior portions of the furniture members, leaving the exterior with clean lines and an aesthetic appeal. In these or other embodiments, the furniture connectors and/or fastening elements may be made in various colors and/or textures that can be selected to be complementary to and/or visually blend in with the colors and/or textures of the furniture members, and in certain configurations, they may be visible in the completed furniture assembly to render a desired visual effect.

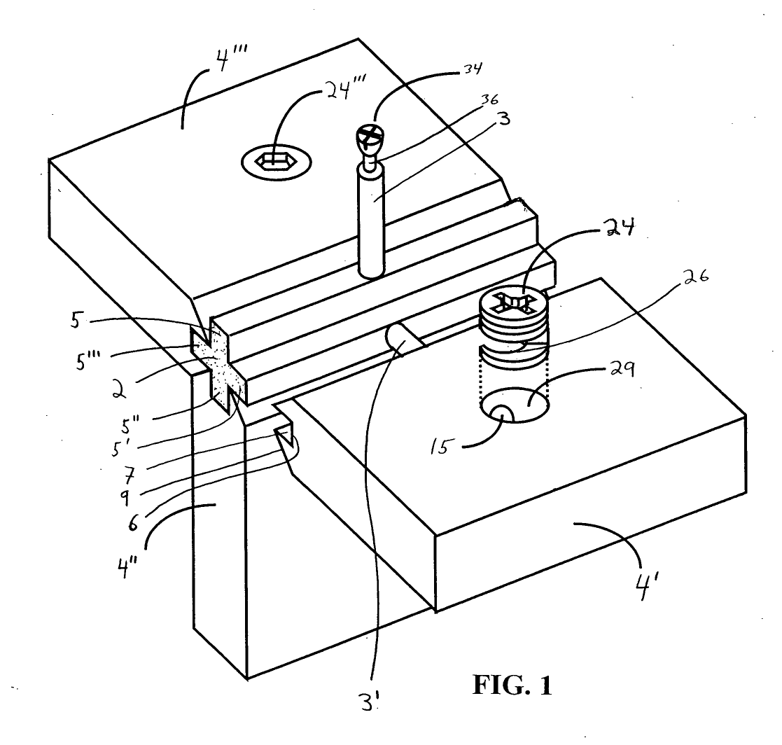

FIG. 1 shows a perspective view of one embodiment of a furniture connector 2 being used in association with connecting elements 3, 3′ and furniture members 4′, 4″ and 4′″. In this embodiment, furniture connector 2 includes four furniture-engaging portions 5, 5′, 5″ and 5′″. Two additional connecting elements connect furniture members 4″ and 4′″ to furniture-engaging portions 5″ and 5′″ respectively, but are not visible in FIG. 1. Connecting element 3′ is attached to furniture-engaging portion 5′ and inserted through a passage that extends from a base 6 of a groove 7 to an opening 15 in the sidewall of a recess 29 configured for receiving a fastening element 24. Furniture-engaging portion 5′ is accepted by groove 7 and fastening element 24 engages connecting element 3′ to tighten and secure furniture member 4′ to furniture connector 2. Furniture connector 2 is configured to interconnect two, three or four furniture members. As will be apparent to one of skill in the art, furniture connectors may be provided which are able to interconnect no more than three furniture members or no more than two furniture members. Furniture connectors able to interconnect five or more furniture members also may be provided.

In some embodiments, a plurality of connecting elements 3 may be provided on a given furniture-engaging portion at discrete locations along the length of the furniture-engaging portion. In some embodiments, numerous holes for attachment of connecting elements 3 may be provided, but only a subset of the holes may be used in certain configurations depending on the strength of connection desired between the furniture connector and the furniture member(s).

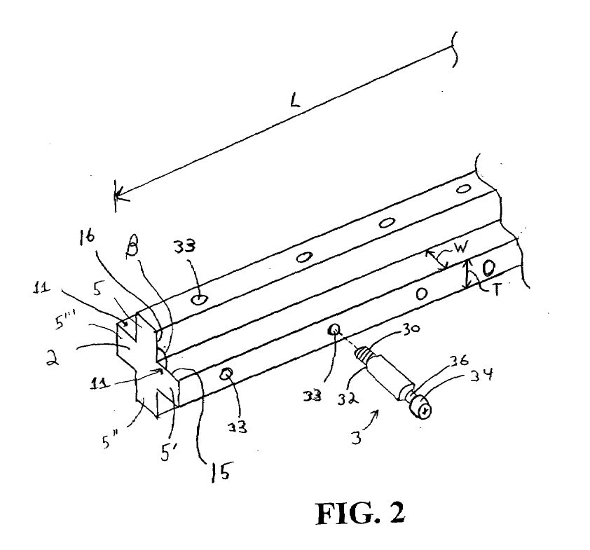

In some embodiments, connecting element 3 is a bolt and fastening element 24 is a cam lock, each may be, for example, identical or similar to the bolts and cam locks described in U.S. Pat. No. 4,886,326 to Kuzyyk. With reference to FIG. 2, the bolt 3 may include a threaded shank portion 30 which engages furniture-engaging portion 5′ at a threaded hole 33. A shoulder 32 limits the depth of insertion of the bolt into furniture-engaging portion 5′. A head 34 and a neck 36 are disposed on the opposite end of the bolt for engagement with fastening element 24. For purposes herein, the bolts are considered to be elongated connecting elements because when they are attached to the furniture connector in their connecting configuration, the length of the bolts in the extending essentially radially away from the furniture-engaging portion of the connector is greater than the thickness of the bolts. In some embodiments, connecting elements which are not elongated may be used. Referring back to FIG. 1, fastening element 24 may be a cam-lock such as a quarter-turn cam lock having an internal wall 26 with a decreasing radius so as to pull the bolt inwardly into recess 29 upon rotation of the cam lock when engaged with the bolt. As will be apparent to one of skill in the art, any suitable fastening element may be used to engage an associated connecting element.

In alternative embodiments (not shown), the connecting elements may be attached to the furniture connector in a manner other than with a threaded portion. For example, the connecting elements may be pivotally or otherwise movably attached to the furniture connector such that the connecting elements are attached at the time or place of manufacture of the furniture connection, yet do not protrude significantly from the furniture connector during transport. At the time of assembly, the connecting elements may be positioned to extend essentially radially outwardly from the furniture connector, and engaged with fastening elements as described above.

In still another alternative embodiment (not shown), the connecting element and fastening element arrangement may be reversed such that a connecting element is initially attached to the furniture member within a groove of the furniture member, and a passage for the connecting element is present in the furniture-engaging portion of the connector. In this embodiment, a fastening element may be disposed within the furniture connector to attach the connecting element to the furniture connector, thus securing the furniture member and the furniture connector together.

Returning to the embodiments of FIGS. 1 and 2, furniture-engaging portions 5 are shown to be configured as rails, that is, components that extend along at least a portion of the furniture connector length and are configured to be inserted into grooves in a furniture member. A rail may vary in width along its length, it may vary in length along its width, and its thickness may vary as well. Different rails of the same furniture connector may have similar shapes and dimensions, or they may have different shapes and dimensions.

In some embodiments, such as the one shown in FIG. 2, the length of furniture-engaging portion 5 is greater than its width. Furniture-engaging portion 5 need not be continuous in some embodiments. For example, in certain embodiments, the furniture connector may extend essentially the entirety of the length of a furniture member to which it is configured to be attached, but furniture-engaging portion 5 may have several separate sections spaced periodically along its overall length. In some embodiments, furniture connector 2, or certain furniture-engaging portions of furniture connector 2, may not extend lengthwise all the way to the end or ends of the furniture members to which it is connected.

Although furniture connector 2 in FIG. 2 is shown as having similar or identical furniture-engaging portions 5, 5′, 5″, 5′″, in other embodiments, a furniture connector may include furniture-engaging portions which are not similar to one another. In some embodiments, the widths, thicknesses and/or lengths of the furniture-engaging portions of a furniture connector may be different from one another for a given furniture connector and/or between different furniture connectors used to interconnect a plurality of furniture members into a piece of assembled furniture. For purposes herein, the width of a furniture-engaging portion at a particular point along the length of the connector is the distance, as measured essentially perpendicular to the length of the connector, from an outermost portion of the furniture-engaging portion to an inner portion of the furniture-engaging portion where the furniture-engaging portion cannot be further engaged with a groove in a furniture member.

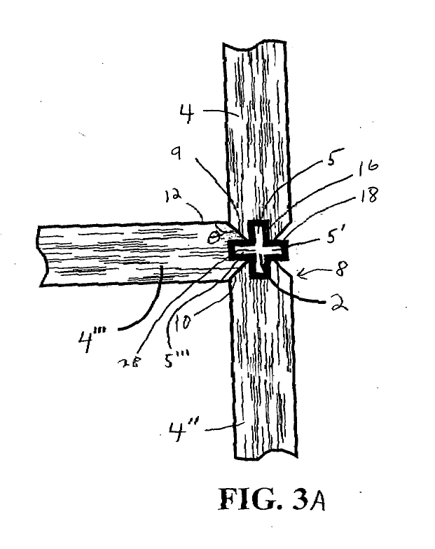

FIG. 3A is an end view of a furniture assembly including furniture connector 2 and three interconnected furniture members 4, 4″ and 4′″. Furniture connector 2 may include an end cap 28 or an end plug when the furniture connector is a hollow piece.

The furniture members shown in this embodiment include connecting sides 8 that are beveled. The beveled connecting sides allow connecting sides 8 to meet in a symmetrical arrangement while maintaining intimate contact between faces 9 of connecting sides 8. In other embodiments, connecting sides 8 need not be beveled, nor, in all embodiments, are faces 9 of connecting sides 8 required to intimately contact one another as illustrated.

In this embodiment, furniture member 4′″ has a connecting side with an angled face portion 9 which forms an interior angle θ with an adjacent face 12 of the furniture member 4′″ of about 135°. A similarly angled face portion 10 is present opposite to face portion 9. Each furniture member 4, 4″, and 4′″ has similar interior angles, and as such, at each of the regions of intersections of the members, the faces of the connecting sides are in intimate contact, thereby eliminating gaps or open spaces. In other embodiments, connecting sides may have one or more faces arranged at larger angles with respect to adjacent faces of the furniture member than illustrated, which may allow for a greater number of furniture members to be connected by a furniture connector, while still permitting intimate contact of connecting side faces. In still other embodiments, smaller angles than illustrated may be used which could be selected to allow up to three (about 120°) or only two (about 90°—i.e., connecting face portions essentially coplanar to each other and essentially normal to the adjacent faces of the furniture member) to be connected by one furniture connector, while permitting intimate contact between the faces. As mentioned immediately above, in certain embodiments, angled portion 9 may form an essentially 90° interior angle with adjacent face 12 and angled portion 10 may form an essentially 90° interior angle with its adjacent face to provide a squared-off connecting edge. In still further embodiments, a single angled portion may extend across the entire thickness of the furniture member. The furniture members and connectors may be constructed such that the furniture members become interconnected relative to one another at angles α other than about 90° as illustrated.

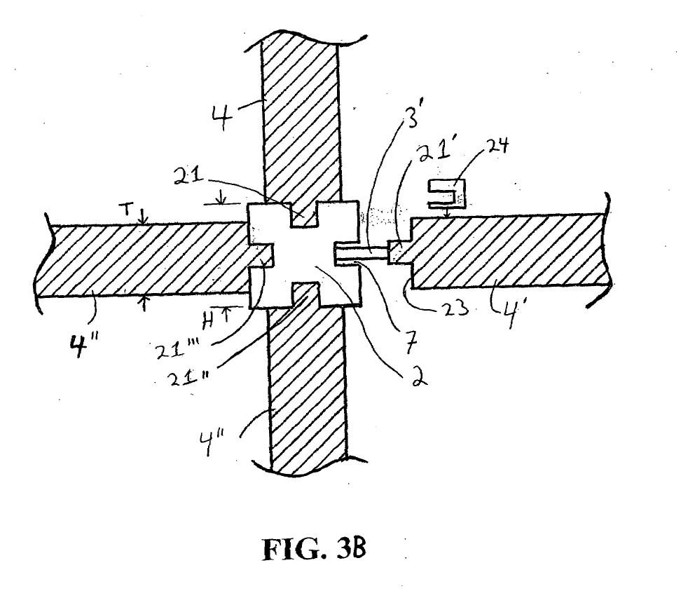

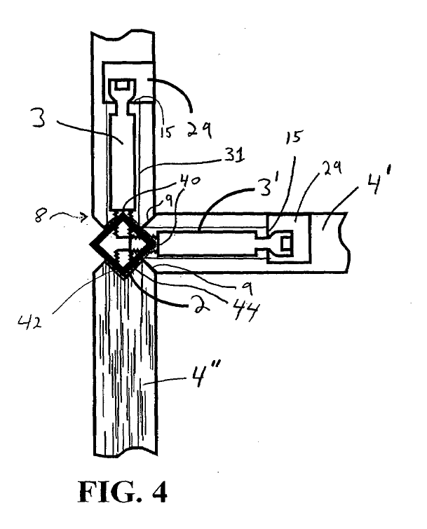

As can be seen in FIG. 2 and the end view of FIG. 3A, the furniture-engaging portions may form concave areas 11 with one another. For example, sidewalls 16 and 18 of furniture-engaging portions 5 and 5′, respectively, are essentially perpendicular to one another and form an exterior angle β of 90°. In some embodiments, the sidewalls of the furniture-engaging portions do not form essentially 90° exterior angles, but form exterior angles having a smaller or larger angle at the intersection of the sidewalls, but less than 180°. In some embodiments (see, for example, FIG. 4), intersections of furniture-engaging portions may not form exterior angles of less than 180°. In still other embodiments, the sidewalls do not meet at an abrupt angle, but instead may form an exterior angle with a smooth contour. In yet another embodiment, sidewalls of adjacent furniture-engaging portions may not meet at all and instead may form an exterior angle of less than 180° with an interior portion of the furniture connector. For example, an interior portion of the furniture connector may be square in cross-section, and have furniture-engaging portions which are rails having thicknesses that are smaller than the sides of the square.

According to an alternative embodiment of a furniture system, grooves may be present in the furniture connector, and furniture connector-engaging portions may be disposed on the furniture members. For example, as shown in FIG. 3B, furniture connector 2 includes four grooves 7 to which connecting elements such as connecting element 3′ may be attached. A passage may extend through a furniture connector-engaging portion 21′ into furniture member 4′. Connecting element 3′ may be inserted through the passage and furniture connector-engaging portion 21′ may be inserted into groove 7. To secure furniture member 4′ to furniture connector 2, fastening element 24 may be used to attach connecting element 3′ to furniture member 4′ by inserting fastening element 24 into a fastening element recess that intersects with the passage that extends through the furniture-engaging portion 21′. The furniture connector shown in FIG. 3B may be used to interconnect two, three or four furniture members, and when interconnecting two or three furniture members, the unused sides of the furniture connector may not protrude unacceptably from the general contours of the assembled piece of furniture. The furniture system embodiment of FIG. 3B may be particularly advantageous when connecting horizontal boards to a leg of a piece of furniture. As with many of the embodiments described herein, an assembly which includes two or three furniture members may be expanded with third and/or fourth furniture members without disassembling a portion of the assembly.

Each furniture member shown in FIG. 3B as having a thickness that is smaller than the height of the associated cross-sectional side of the furniture connector. In some embodiments, the thicknesses of the furniture members may be substantially equal to the heights of the associated cross-sectional sides. In further embodiments, the furniture members may have thicknesses greater than the heights of the sides of the furniture connector, but as in the embodiment of FIG. 3A, the connecting sides may be beveled. With beveled connecting sides, the thickness of the furniture member at the interface of a furniture member and a furniture connector may be substantially equal to the height of the furniture connector.

A furniture assembly including another alternative embodiment of a furniture connector 2 is shown in FIG. 4. Furniture connector 2 is substantially square in cross-section and has passages formed in edges 40 for receiving connecting elements 3, 3′. In this manner, each furniture member 4, 4′, 4″ accepts a furniture-engaging portion of the furniture connector, and faces 9 of the connecting sides of the furniture members are in contact with one another. In some embodiments, faces a may not contact each other.

In this embodiment, the grooves formed in furniture members have two walls 42, 44 forming an essentially v-shape rather than having two essentially parallel walls and an essentially perpendicular base as in the embodiment shown in FIG. 3A. In both of the embodiments described above with reference to FIGS. 3A and 4, the unused furniture-engaging portion of furniture connector 2 does not protrude beyond a plane coplanar to the furniture members attached to the two opposing furniture-engaging portions (e.g. furniture members 4 and 4″ in FIG. 3A). In this manner, a furniture connector having four furniture-engaging portions but only engaging three furniture members, for example, may be used on an exterior side of a furniture assembly without protruding substantially beyond the general contours of the furniture assembly. Additionally, a single type of furniture connector (e.g. a connector having four furniture-engaging portions) may be used at various interconnections, for example, the interconnection of two, three or four furniture members. By employing a single type of furniture connector, manufacturing and assembly may be simplified.

Two of the furniture members are shown in cross-section in FIG. 4 so that the connecting elements (e.g., bolts) are visible. As with the embodiments described above with reference to FIGS. 1 and 3A, connecting elements 3 and 3′ are inserted through a passage 31, through opening 15, and into fastening element recess 29. As described above, cam locks (not shown) may be inserted into fastening element recesses 29 prior to inserting the bolts into recesses 29. Once the bolts are substantially inserted, the cam lock may be turned to engage the bolt. In some embodiments, such as the embodiments shown in FIG. 4, final attachment occurs when the furniture-engaging portion contacts the base and/or walls of the groove. In some embodiments, for example, embodiments using components similar to those in FIG. 3B and with a furniture connector-engaging portion 21′ which cannot reach the base of groove 7, final attachment occurs when a face 23 of a connecting side contacts furniture connector 2. In some embodiments, a furniture member may be considered to be attached to a furniture connector even if there is incomplete contact of the furniture-engaging portion or other portion of the furniture connector with the groove of the furniture member.

While FIG. 1 shows two embodiments of a tool engagement head for fastening element 24, i.e., a phillips-head screwdriver head and a hex-key head, in some embodiments fastening element 24 may permit tool-free operation. For example, the fastening element may have a finger grip or other structure for rotating, sliding, pushing, pulling or otherwise operating the fastening element without the need for tools.

Adhesive may be used, if desired, to make certain connections permanent, for example, by including adhesive material in groove 7 before inserting a furniture-engaging portion of a furniture connector in the groove and securing it with a fastening element. An adhesive connection as formed directly between furniture members or as used to secure an interconnection between two furniture members via connection of each furniture member to a furniture connector, wherein all of the connections are secured solely by the use of adhesive, however, is not considered to be use of a “connecting element” or “fastening element” as those terms are used herein. In some embodiments, however, a first furniture-engaging portion may be reversibly fastened to a furniture member via a fastening element of the invention, and a second furniture-engaging portion may be permanently attached with the addition of adhesive.

FIGS. 1-4 show only a few of a wide variety of connecting elements and fastening element designs. These embodiments are intended to be exemplary and other suitable fastening elements and connecting elements that would become apparent to those skilled in the art upon consideration of the teachings herein or could be developed or discerned using no more than ordinary skill in the art and/or routine experimentation and optimization may be used instead of or in addition to the particular embodiments described herein, and such fastening elements and connecting elements configurations that fall within the scope of the claims are within the scope of the invention.

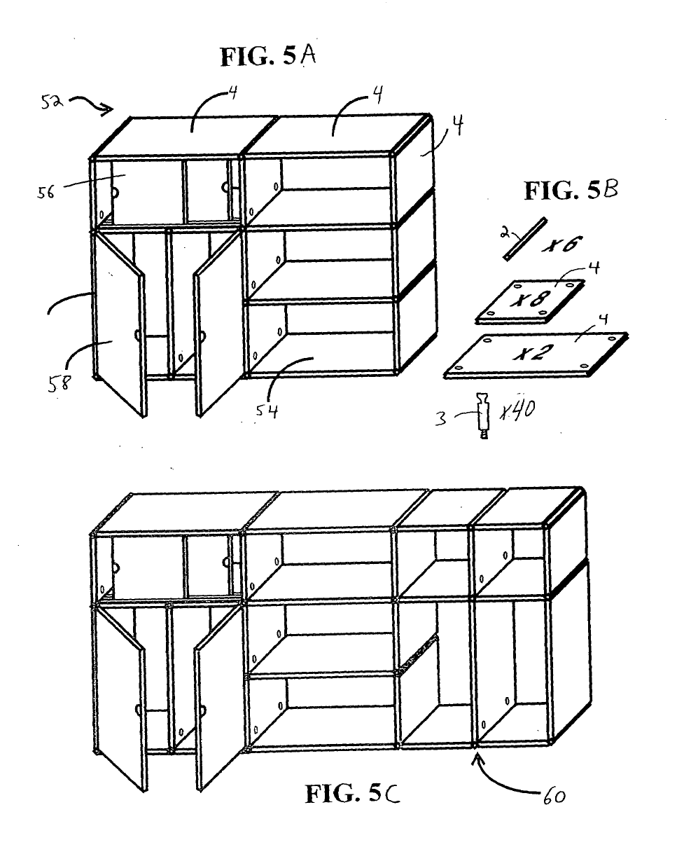

The reversibility of connections, provided according to certain embodiments of the invention, can permit improved versatility when adding extensions to furniture assemblies. One example of this versatility is shown in the embodiment of FIGS. 5A-5C. A furniture assembly 52 comprising a plurality of furniture members 4 includes several shelves 54, sliding doors 56, and swinging doors 58. Various embodiments of connectors disclosed herein may be used to interconnect the furniture members 4. An extension 60 may be added to furniture assembly 52 by using additional furniture members 4, connectors 2 and connecting elements 3 (see FIG. 5B). For example, connecting elements 3 may be added to the outwardly-facing furniture-engaging portions present on the right side of the furniture assembly 52. Horizontal shelves may then fastened to the connecting elements according to embodiments described herein. Furniture members may then be installed vertically to provide support, and additional shelves optionally may be added to further extend the furniture assembly. As a result of adding onto the connectors on the right side of furniture assembly 52, the presence of double walls is avoided when addition 60 is appended.

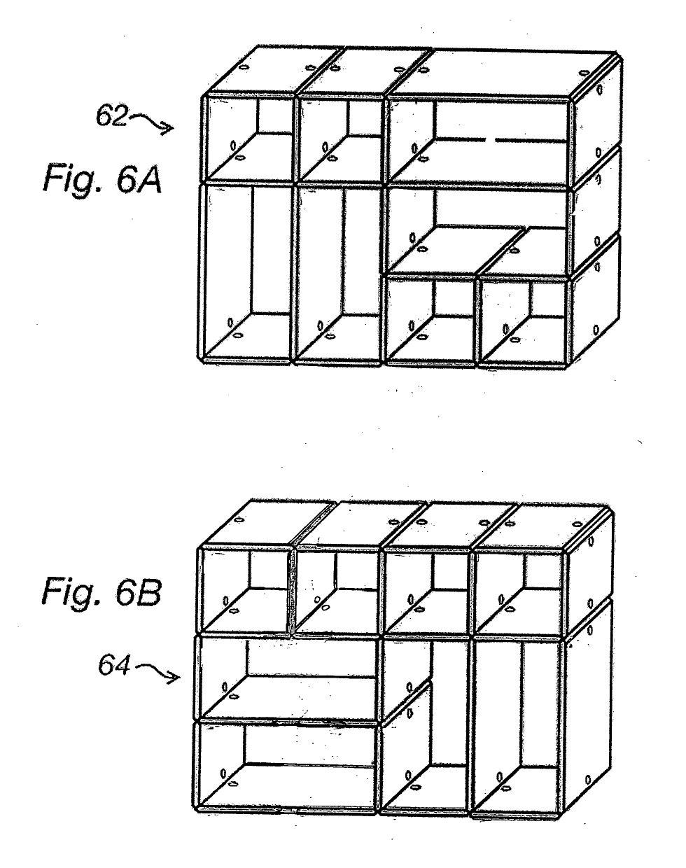

The ability to add or subtract furniture members from furniture assemblies enabled via use of inventive furniture connectors and furniture members according to certain embodiments of the invention, also may allow for versatility in assembling/reassembling/expanding furniture assemblies in different configurations. For example, as shown in FIGS. 6A and 6B, a furniture assembly assembled in a first configuration 62 can be disassembled (either partially or entirely) and reassembled in a second configuration 64 using some or all of the same components originally making up assembly 62. For example, in an exemplary embodiment, a kit of parts comprising a plurality of furniture members, furniture connectors, connecting elements, and fastening elements of the invention and/or custom inserts for furniture members allowing attachment of doors, shelves, wheels, handles, etc. could be provided, which could be assembled into a plurality of different furniture configurations, for example a desk, a bookcase, an entertainment center, a cabinet, etc. Instructions could be provided with such a kit instructing a user as to how to assemble, dissemble, and reassemble the various provided components into the variety of furniture configurations. Various kits may have different types and different quantities of various components, and additional components could be sold separately and combined into “expansion” kits.

In some embodiments, more than one face of various furniture members may be presentable as an exterior face of a furniture assembly. In combination with various connection systems disclosed herein, such furniture members may allow users to choose whether fastening elements will be visible in the assembled furniture assembly or not, or may allow users to decide which color or surface texture will be visible on the exterior of the furniture assembly.

“Instructions” can and often do define a component of promotion, and typically involve written instructions on or associated with packaging of kits or components of the invention. Instructions also can include any oral or electronic instructions provided in any manner. The “kit” typically, and preferably, defines a package including both any one or a combination of the components of the invention and the instructions, but can also include the components of the invention and instructions of any form that are provided in connection with the components in a manner such that a purchaser or user of the components will clearly recognize that the instructions are to be associated with the specific components.

As discussed above, even though furniture members can be securely interconnected to one another using embodiments of the furniture connectors disclosed herein, in certain embodiments the connection is reversible so that the furniture members can be disconnected and furniture assemblies can be disassembled, without difficulty and without adversely altering the structure of the furniture members and furniture connectors. For example, in the embodiment of FIG. 1, by rotating fastening element 24 counterclockwise, internal wall 26 disengages from head 34 and neck 36 of connecting element 3′. With fastening element 24 disengaged from connecting elements 3′, connecting element 3′ may be removed from its passage and furniture-engaging portion 5′ can be pulled from furniture member 4′.

While several embodiments of the invention have been described and illustrated herein, those of ordinary skill in the art will readily envision a variety of other means and structures for performing the functions and/or obtaining the results or advantages described herein, and each of such variations, modifications and improvements is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention. In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of” and “consisting essentially of” are to be interpreted as closed or semi-closed phrases, respectively.

What is claimed is:

1. A furniture system comprising:
a furniture connector extending in a lengthwise direction and including a plurality of furniture-engaging portions;
a plurality of furniture members, at least two of the plurality of furniture members each including a groove formed at or near a connecting side of the furniture member, the groove configured to accept a furniture-engaging portion of the connector;
a plurality of elongated connecting elements; and
a plurality of fastening elements; wherein
for each of the at least two furniture members, at least one elongated connecting element extends between a furniture-engaging portion of the connector and the furniture member at a discrete location along the length of the connector, and the at least one connecting element and at least one fastening element are configured to engage one another to secure the furniture-engaging portion within the groove of the furniture member.

2. A furniture system as in claim 1, wherein, for each of the at least two furniture members, the at least one elongated connecting element is attached to and extends away from a furniture-engaging portion of the connector at a discrete location along the length of the connector, and the at least one fastening element is configured to attach the at least one elongated connecting element to a furniture member to secure the furniture member to the furniture-engaging portion of the furniture connector.

3. A furniture system as in claim 2, wherein the at least one elongated connecting element comprises a threaded portion that secures the connecting element to the furniture-engaging portion of the furniture connector.

4. A furniture system as in claim 3, wherein the at least one elongated connecting element comprises a neck portion and a head portion configured to engage a fastening element.

5. A furniture system as in claim 2, wherein the at least one fastening element comprises a cam lock.

6. A furniture system as in claim 2, wherein each furniture-engaging portion is disposed at a right angle to at least one other furniture-engaging portion.

7. A furniture system as in claim 2, wherein the furniture connector comprises four furniture-engaging portions, each furniture-engaging portion extending outwardly in a direction perpendicular to two of the remaining furniture-engaging portions.

8. A furniture system as in claim 2, wherein the connecting side of at least one of the furniture members comprises a first angled portion forming a interior angle with respect to an adjacent face of the furniture member of greater than about 90 degrees;
wherein the connecting side has a thickness and the first angled portion extends less than halfway across the thickness of the connecting side;
wherein the connecting side has a second angled portion forming a interior angle with respect to an adjacent face of the furniture member of greater than about 90 degrees; and
wherein the second angled portion extends less than halfway across the thickness of the connecting side.

9. A furniture system as in claim 1, wherein, for each of the at least two furniture members, the at least one elongated connecting element comprises two elongated connecting elements which extend between a furniture-engaging portion of the connector and the furniture member at discrete locations along the length of the connector.

10. A furniture system as in claim 2, wherein the plurality of furniture-engaging portions comprises at least first, second, third and fourth furniture-engaging portions extending outwardly from the furniture connector, and wherein each furniture-engaging portion forms an exterior angle of less than 180 degrees with the furniture connector and/or an adjacent furniture-engaging portion.

11. A furniture system as in claim 2, wherein the plurality of furniture-engaging portions comprises at least first, second, third and fourth furniture-engaging portions comprising edges of the furniture connector extending in the lengthwise direction along at least a portion of the length of the furniture connector, each edge being formed by the intersection of two substantially planar surfaces of the furniture connector, each of the edges including at least one hole formed in the edge, each hole being configured to accept and attach a connecting element.

12. A furniture system comprising:
a plurality of furniture members, at least two of the plurality of furniture members each including a furniture connector-engaging portion formed at or near a connecting side of the furniture member;
a furniture connector extending in a lengthwise direction and including a plurality of grooves, at least two of the grooves each configured to accept a furniture connector-engaging portion of one of the at least two furniture members;
a plurality of elongated connecting elements; and
a plurality of fastening elements; wherein
for each of the at least two furniture members, at least one elongated connecting element is attached to the furniture connector and extends away from the furniture connector at a discrete location along the length of the connector, and the at least one connecting element is configured to engage a fastening element to secure the furniture connector-engaging portion of the furniture member within a groove of the furniture connector.

13. A furniture connection system comprising:
a furniture connector extending in a lengthwise direction and including at least first, second and third furniture-engaging portions comprising edges of the furniture connector extending in the lengthwise direction along at least a portion of the length of the furniture connector, each of the first, second and third edges being formed by the intersection of two substantially planar surfaces of the furniture connector, each of the first, second and third edges including at least one hole formed in the edge, each hole being configured to accept and attach an elongated connecting element; and
a plurality of elongated connecting elements configured for attachment in the holes.

14. A furniture connection system as in claim 13, wherein the furniture connector includes a fourth furniture-engaging portion comprising an edge of the furniture connector extending along at least a portion of the furniture connector in the lengthwise direction, the fourth edge being formed by the intersection of two substantially planar surfaces, the fourth edge including at least one hole formed in the edge, the hole being configured to accept and attach an elongated connecting element.

15. A furniture connection system as in claim 13, wherein the connecting elements comprise a threaded portion that secures the connecting elements to the furniture-engaging portion of the furniture connector.

16. A furniture connection system as in claim 13, further comprising first and second furniture members, each furniture member having a groove configured to receive an edge comprising a furniture-engaging portion of the furniture connector, wherein each groove includes at least one hole for receiving an elongated connecting element when the connecting elements are attached to the furniture connector.

17. A furniture connection system as in claim 16, further comprising cam locks configured to be placed within holes in the first and second furniture members, and configured to attach the elongated connecting elements to secure the furniture members to the furniture-engaging portions.

18. A furniture connection system as in claim 13, wherein the holes are configured such that the elongated connecting elements are perpendicular to one another when attached to the furniture connector.

19. A method of assembling a piece of furniture comprising:
providing a longitudinally-extending furniture connector with at least first and second furniture-engaging portions;
attaching a plurality of connecting elements to the first and second furniture-engaging portions;
providing first and second furniture members, each furniture member having a groove at or near a connecting side of the furniture member, and additionally having passages disposed in a base and/or wall of the groove, and further including fastening element holes intersecting with the passages;
inserting fastening elements into the fastening element holes of the first and second furniture members;
inserting the connecting elements that are attached to the first furniture-engaging portion into the passages in the base and/or wall of the groove of the first furniture member;
engaging the fastening elements with the connecting elements of the first furniture-engaging portion to attach the connecting elements to the first furniture member, thereby securing the first furniture member to the furniture connector;
inserting the connecting elements that are attached to the second furniture-engaging portion into the passages in the base of the groove of the second furniture member; and
engaging the fastening elements with the connecting elements of the second furniture-engaging portion to attach the connecting elements to the second furniture member, thereby securing the second furniture member to the furniture connector.

20. A method of assembling a piece of furniture as in claim 19, wherein providing a longitudinally-extending furniture connector with at least first and second furniture-engaging portions comprises providing a longitudinally-extending furniture connector with four furniture-engaging portions; the method further comprising:
attaching a plurality of connecting elements to the third and fourth furniture-engaging portions;
providing third and fourth furniture members, each furniture member having a groove at or near a connecting side of the furniture member, and additionally having passages disposed in a base and/or wall of the groove, and further including fastening element holes intersecting with the passages;
inserting fastening elements into the fastening element holes of the third and fourth furniture members;
inserting the connecting elements that are attached to the third furniture-engaging portion into the passages in the base and/or wall of the groove of the third furniture member;
engaging the fastening elements with the connecting elements of the third furniture-engaging portion to attach the connecting elements to the third furniture member, thereby securing the third furniture member to the furniture connector;
inserting the connecting elements that are attached to the fourth furniture-engaging portion into the passages in the base of the groove of the fourth furniture member; and
engaging the fastening elements with the connecting elements of the fourth furniture-engaging portion to attach the connecting elements to the fourth furniture member, thereby securing the fourth furniture member to the furniture connector.
